(19) United States
(12) Patent Application Publication
(10) Pub. No.: US 2015/0227198 A1
(43) Pub. Date: Aug. 13, 2015

(54) HUMAN-COMPUTER INTERACTION METHOD, TERMINAL AND SYSTEM

(71) Applicant: Tencent Technology (Shenzhen) Company Limited, Shenzhen (CN)

(72) Inventors: Jin FANG, Shenzhen (CN); Mu TANG, Shenzhen (CN); Yan CHEN, Shenzhen (CN); Jian DU, Shenzhen (CN); Jingbiao LIANG, Shenzhen (CN); Tao WANG, Shenzhen (CN); Xi WAN, Shenzhen (CN); Jinsong JIN, Shenzhen (CN); Jun CHENG, Shenzhen (CN)

(21) Appl. No.: 14/690,263

(22) Filed: Apr. 17, 2015

Related U.S. Application Data
(63) Continuation of application No. PCT/CN2013/078373, filed on Jun. 28, 2013.

(30) Foreign Application Priority Data
Oct. 23, 2012 (CN) 201210407429.3

(51) Int. Cl. G06F 3/01

(52) U.S. Cl. CPC G06F 3/014; G06F 3/017

(57) ABSTRACT

Embodiments of the present disclosure disclose a human-computer interaction method, including: acquiring positions and/or motion tracks of multiple auxiliary light sources in a captured area by using a camera; acquiring a corresponding operation instruction according to a combined gesture formed by the acquired positions and/or motion tracks of the multiple auxiliary light sources in the captured area; and executing the acquired operation instruction. The embodiments of the present disclosure further disclose a human-computer interaction terminal and system. By using the present disclosure, interference immunity of gesture input can be improved, thereby improving accuracy of manipulation.

### RELATED APPLICATIONS

This patent application is a continuation application of PCT Patent Application No. PCT/CN2013/078373, entitled “HUMAN-COMPUTER INTERACTION METHOD, TERMINAL AND SYSTEM” filed on Jun. 28, 2013, which claims priority to Chinese Patent Application No. 201210407429.3, entitled “HUMAN-COMPUTER INTERACTION METHOD, TERMINAL AND SYSTEM” filed with Chinese Patent Office on Oct. 23, 2012, both of which are incorporated herein by reference in their entirety.

### FIELD OF THE TECHNOLOGY

The subject and content disclosed herein relate to the technical field of human-computer interaction, and in particular, to a human-computer interaction method and a related terminal and system.

### BACKGROUND OF THE DISCLOSURE

Human-computer interaction techniques generally refer to technologies that implement a conversation between a human and a human-computer interaction terminal (for example, a computer, a smartphone, or the like) in an effective manner by using an input device and an output device of the human-computer interaction terminal. It is included that the human-computer interaction terminal provides a lot of related information and prompts and requests for the human by using the output device or a display device, and by inputting a related operation instruction to the human-computer interaction terminal by using the input device, the human can control the human-computer interaction terminal to execute a corresponding operation instruction. The human-computer interaction techniques are one of the important content in computer user interface design, and are closely related to subject areas such as cognitive science, human engineering, and psychology.

The human-computer interaction techniques have already gradually evolved into touch screen input and gesture input from original keyboard input and mouse input, where the gesture input has advantages such as intuitive manipulation and high user experience, and is increasingly favored by people. However, in an actual application, the gesture input is generally implemented by directly capturing and understanding a gesture by using an ordinary camera. It is found in practice that, interference immunity of the directly capturing and understanding a gesture by using an ordinary camera is poor, thereby causing low manipulation accuracy.

### SUMMARY

In the existing technology, interference immunity of directly capturing and understanding a gesture by using an ordinary camera is poor, and low manipulation accuracy is caused.

In view of the above, according to one aspect of the present disclosure, a human-computer interaction method is provided to be implemented at a terminal device, which can improve interference immunity of gesture input, thereby improving accuracy of manipulation. The human-computer interaction method is performed at a terminal device having one or more processors and memory for storing program modules to be executed by the one or more processors, the method further including: acquiring positions and/or motion tracks of multiple auxiliary light sources in a captured area by using a camera; acquiring a corresponding operation instruction according to a combined gesture formed by the acquired positions and/or motion tracks of the multiple auxiliary light sources in the captured area; and executing the acquired operation instruction.

Correspondingly, according to another aspect of the present disclosure, a human-computer interaction terminal is further provided, the human-computer interaction terminal including one or more processors, memory, and one or more program modules stored in the memory and to be executed by the one or more processors, the one or more program modules further including: a light source capture module, acquiring positions and/or motion tracks of multiple auxiliary light sources in a captured area by using a camera; an operation instruction acquisition module, acquiring a corresponding operation instruction according to a combined gesture formed by the acquired positions and/or motion tracks of the multiple auxiliary light sources in the captured area; and an instruction execution module, executing the acquired operation instruction.

Correspondingly, according to yet another aspect of the present disclosure, a non-transitory computer readable medium storing one or more program modules, wherein the one or more program modules, when executed by a human-computer interaction terminal having one or more processors, cause the human-computer interaction terminal to perform the following steps: acquiring positions and/or motion tracks of multiple auxiliary light sources in a captured area by using a camera; acquiring a corresponding operation instruction according to a combined gesture formed by the acquired positions and/or motion tracks of the multiple auxiliary light sources in the captured area; and executing the acquired operation instruction.

It can be known from the foregoing technical solutions that, in the foregoing aspects of the present disclosure, positions and/or motion tracks of auxiliary light sources in a captured area are acquired by using a camera, so that an operation instruction corresponding to the positions and/or motion tracks of the auxiliary light sources can be acquired, and the operation instruction can be executed. It can be seen that, in the human-computer interaction method provided by the present disclosure, human-computer interaction is based on the auxiliary light sources, which not only has very good interference immunity and higher manipulation accuracy, but also has a good commercial value.

### BRIEF DESCRIPTION OF THE DRAWINGS

To describe the technical solutions in the embodiments of the present disclosure or in the existing technology more clearly, the following briefly introduces the accompanying drawings required for describing the embodiments or the existing technology. Apparently, the accompanying drawings in the following description show merely some embodiments of the present disclosure, and a person of ordinary skill in the art may still derive other drawings from these accompanying drawings without creative efforts.

FIG. 1 is a flowchart of a human-computer interaction method according to the present disclosure;

FIG. 2 is a schematic diagram showing that auxiliary light sources are disposed on a component suitable for being worn on a human hand according to the present disclosure;

FIG. 3 is a schematic diagram of a process of processing an image acquired by a camera in a human-computer interaction method according to an embodiment of the present disclosure;

FIG. 4 is a schematic diagram of area division of a captured area in a human-computer interaction method according to an embodiment of the present disclosure;

FIG. 5 is a schematic diagram of a motion track of auxiliary light sources in a captured area according to an embodiment of the present disclosure;

FIGS. 6A-6D are schematic diagrams of combined gestures in a human-computer interaction method according to an embodiment of the present disclosure; and

FIG. 7 is a structural diagram of a human-computer interaction terminal according to an embodiment of the present disclosure.

### DESCRIPTION OF EMBODIMENTS

The following describes embodiments of the present disclosure in detail with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

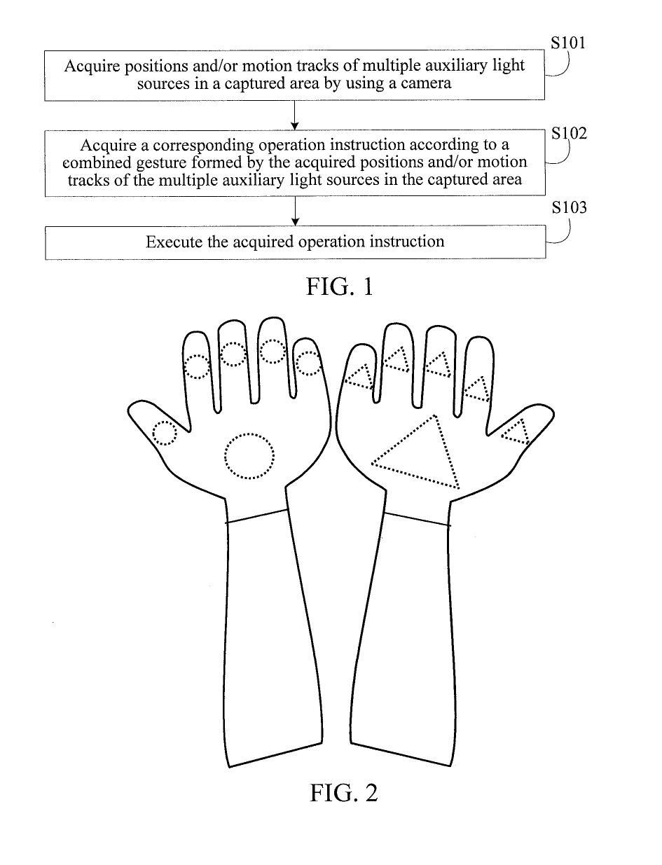

FIG. 1 is a flowchart of a human-computer interaction method according to an embodiment of the present disclosure. As shown in FIG. 1, the human-computer interaction method in this embodiment starts from step S101.

Step S101: Acquire positions and/or motion tracks of multiple auxiliary light sources in a captured area by using a camera.

In an embodiment implementing the present disclosure, a human-computer interaction terminal executing the human-computer interaction method may be a computer, a smartphone, a television, or various home intelligent devices, commercial intelligent devices, office intelligent devices, mobile Internet devices (MID), and the like that is loaded with control software and has a computing capability, which is not specifically limited in this embodiment of the present disclosure. The camera may be built in the human-computer interaction terminal, where the human-computer interaction terminal includes, but is not limited to, a terminal device such as: a notebook computer, a tablet, a smartphone, and a personal digital assistant (PDA), for example, a camera built in a terminal such as a notebook computer, a smartphone, a tablet, and a PDA; and the camera may also be externally connected to the human-computer interaction terminal, for example, the camera may be connected to the human-computer interaction terminal by using a universal serial bus (USB), or may be connected to the human-computer interaction terminal by using a wide area network (WAN), or the camera may also be connected to the human-computer interaction terminal in a wireless manner, such as Bluetooth, Wi-Fi, or infrared. In an embodiment of the present disclosure, the camera may be built in the human-computer interaction terminal, or be externally connected to the human-computer interaction terminal, or the two manners are combined. A connection manner between the camera and the human-computer interaction terminal may be: a wired connection, a wireless connection or a combination of the two connection manners.

The multiple auxiliary light sources mentioned in this embodiment of the present disclosure may be, but is not limited to being, disposed on a component suitable for being worn on a human hand, for example, disposed on auxiliary light source gloves shown in FIG. 2 at multiple positions corresponding to fingers and/or a palm of a human hand. The position or motion track of each auxiliary light source is distinguished according to any one of or a combination of at least two of the size, shape, and color of the multiple auxiliary light sources, for example, a light source at the palm and light sources at the fingers are distinguished by using the luminous area, where a light source with a large luminous area may be disposed at a palm of a glove, and two to five light sources with a small area may be disposed at fingers; and light sources on auxiliary light source gloves of a left hand and a right hand may be distinguished by using light sources whose pattern designs are easy to be identified, or light sources on different auxiliary light source gloves may also be distinguished by using light sources of different colors.

The light sources may be visible-light light sources, and may also be infrared light sources. Correspondingly, when the auxiliary light sources are visible-light auxiliary light sources, the camera is a visible-light camera, and when the auxiliary light sources are infrared light sources, the camera needs to be an infrared camera that can acquire an infrared image.

In an embodiment of the present disclosure, the positions of the auxiliary light sources in the captured area that are acquired by the camera may be the positions of the auxiliary light sources in an image captured by the camera, for example, the image captured by the camera is divided into multiple subareas, and a subarea in which the auxiliary light sources are located is distinguished, so that the relative position of the auxiliary light sources in the captured area can be obtained. In an embodiment, the following steps may be included:

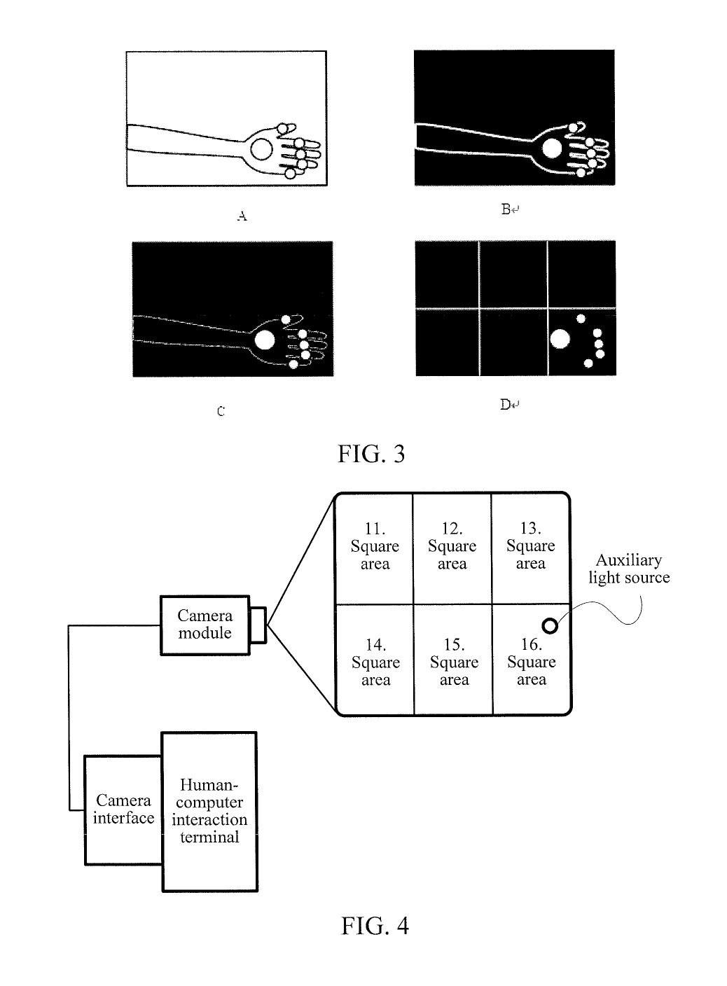

1) The camera captures an image including the auxiliary light sources, and the image is processed, so as to obtain an image that only displays the auxiliary light sources. As shown in FIG. 3, A indicates an image including the auxiliary light sources that is captured by the camera in a normal circumstance. B is an image including the auxiliary light sources that is captured after exposure of the camera is lowered. It can be seen from B that, besides the auxiliary light sources, the image captured by the camera in a low exposure condition further includes a background noise such as a hand shape and other illumination light, where the background noise lowers manipulation accuracy. C indicates an image obtained by performing background noise removal on B, and D indicates an image that only displays the auxiliary light sources (indicated by circles) after the background noise processing is thoroughly completed. The manner and process of performing background noise removal on an image including a background noise are both well-known to a person of ordinary skill in the art, and are not described in this embodiment in detail. In another embodiment, infrared light sources may be used as the auxiliary light sources, and the camera correspondingly is an infrared camera, so that the image D only including the auxiliary light sources can be directly obtained.

2) Determine the positions of the auxiliary light source in the captured area. In this embodiment, as shown in FIG. 4, an image captured by the camera can be divided into multiple square areas. Assuming that the auxiliary light sources fall into a square area numbered 16 in the image captured by the camera, then the human-computer interaction terminal may regard the square area, numbered 16 in the image captured by the camera, into which the auxiliary light sources fall as the position of the auxiliary light sources (indicated by a circle) in the captured area. For the multiple auxiliary light sources shown in FIG. 3, a square area in which an average center-point position of the multiple auxiliary light sources is located may be regarded as the position of the multiple auxiliary light sources in the captured area.

3) If the multiple auxiliary light sources move in the captured area, the multiple auxiliary light sources may be continuously identified by using an image sequence acquired by the camera within a preset continuous time, so that motion tracks of the multiple auxiliary light sources in the captured area can be obtained. If the image captured by the camera is divided into multiple subareas, the number of subareas passed by the auxiliary light sources and a direction thereof may be acquired, where the position or motion track of each auxiliary light source in the captured area may be distinguished according to any one of or a combination of at least two of the size, shape, and color of the multiple auxiliary light sources.

Step S102: Acquire a corresponding operation instruction according to a combined gesture formed by the acquired positions and/or motion tracks of the multiple auxiliary light sources in the captured area. In an embodiment of the present disclosure, the following three different implementation manners are available for acquiring the corresponding operation instruction according to the positions and/or motion tracks of the multiple auxiliary light sources in the captured area: 1) acquiring the corresponding operation instruction according to a combined gesture formed by the multiple positions of the multiple auxiliary light sources in the captured area; 2) acquiring the corresponding operation instruction according to a combined gesture formed by the multiple motion tracks of the multiple auxiliary light sources in the captured area; and 3) acquiring the corresponding operation instruction by acquiring a combined gesture formed by the positions of the multiple auxiliary light sources and a combined gesture formed by the motion tracks of the multiple auxiliary light sources.

In the manner 1), the acquiring the corresponding operation instruction according to a combined gesture formed by the multiple positions of the multiple auxiliary light sources in the captured area may be: querying, according to the square area in which the multiple auxiliary light sources are located in the captured area, a mapping relationship, stored in a code library, between a square area and a code for a code corresponding to the square area in which the auxiliary light sources are located in the captured area, so as to acquire, according to the obtained code, an operation instruction corresponding to the code from a mapping relationship, stored in a code and instruction mapping library, between a code and an operation instruction.

The mapping relationship, stored in the code library, between a square area and a code may be shown as Table 1.

TABLE 1
Mapping relationship, stored in a code library, between a square area and a code

| | Square area parameter (the upper left corner of an image captured by the |
|---|---|
| Code | camera module is regarded as the origin) |
| A | Left boundary = 0, right boundary = the width of the image/3, upper boundary = 0, |
| | and lower boundary = the height of the image/3 |
| B | Left boundary = the width of the image/3, right boundary = the width of the |
| | image * ⅔, upper boundary = 0, and lower boundary = the height of the image/3 |
| C | Left boundary = the width of the image* ⅔, right boundary = the width of the image, |
| | upper boundary = 0, and lower boundary = the height of the image/3 |
| D | Left boundary = 0, right boundary = the width of the image/3, upper boundary = the |
| | height of the image/3, and lower boundary = the height of the image* ⅔ |
| E | Left boundary = the width of the image/3, right boundary = the width of the |
| | image * ⅔, upper boundary = the height of the image/3, and lower boundary = the |
| | height of the image * ⅔ |
| F | Left boundary = the width of the image * ⅔, right boundary = the width of the image, |
| | upper boundary = the height of the image/3, and lower boundary = the height of the |
| | image * ⅔ |
| G | Left boundary = 0, right boundary = the width of the image/3, upper boundary = the |
| | height of the image * ⅔, and lower boundary = the height of the image |
| H | Left boundary = the width of the image/3, right boundary = the width of the |
| | image * ⅔, upper boundary = the height of the image * ⅔, and lower boundary = the |
| | height of the image |
| I | Left boundary = the width of the image * ⅔, right boundary = the width of the image, |
| | upper boundary = the height of the image * ⅔, and lower boundary = the height of |
| | the image * ⅔ |

Table 1 indicates that the human-computer interaction terminal evenly divides the captured image into nine square areas by using the upper left corner of the image captured by the camera as the origin. For example, assuming that a square area parameter of a square area into which the auxiliary light sources fall in the captured image is “left boundary=0, right boundary=the width of the image/3, upper boundary=0, lower boundary=the height of the image/3”, then from the mapping relationship, shown in Table 1 and stored in the code library, between a square area and a code, it can be obtained, according to the square area into which the auxiliary light sources fall in the image captured by the camera module, that a code corresponding to the square area into which the auxiliary light sources fall is A. For another example, assuming that a square area parameter of a square area into which the auxiliary light sources fall in the captured image is that “left boundary=the width of the image*2/3, right boundary=the width of the image, upper boundary=the height of the image*2/3, lower boundary=the height of the image”, then from the mapping relationship, shown in Table 1 and stored in the code library, between a square area and a code, it can be obtained, according to the square area into which the auxiliary light sources fall in the captured image, that a code corresponding to the square area into which the auxiliary light sources fall in the captured image is I. It should be understood by a person skilled in the art that, Table 1 is only an embodiment, and a user may also evenly divide, according to a preference of the user, the image captured by the camera module into more square areas, and customize more codes, so that operations on the human-computer interaction terminal can be diversified, and details are not elaborated herein.

In this embodiment, with reference to the mapping relationship, shown in Table 1 and stored in the code library, between a square area and a code, the mapping relationship, stored in the code and instruction mapping library, between a code and an operation instruction may be shown as Table 2.

TABLE 2
Mapping relationship, stored in the code and instruction mapping library, between a code
and an operation instruction

| Code | Instruction | Description |
|---|---|---|
| A | Turn up volume | When the auxiliary light sources appear at an upper left corner |
| | | of an image captured by the camera, turn up the volume |
| B | Reserved | Reserved |
| C | Switch to a next | When the auxiliary light sources appear at an upper right |
| | channel | corner of the image captured by the camera, switch to the next channel |
| D | Turn down the | When the auxiliary light sources appear at a left central area of the |
| | volume | image captured by the camera, turn down the volume |
| E | Reserved | Reserved |
| F | Reserved | Reserved |
| G | Mute | When the auxiliary light sources appear at a lower left corner |
| | | of the image captured by the camera, mute the sound |
| H | Reserved | Reserved |
| I | Switch to a next | When the auxiliary light sources appear at a lower right corner |
| | channel | of the image captured by the camera, switch to the next |
| | | channel |

In another embodiment, the operation instruction corresponding to the positions of the multiple auxiliary light sources in the captured area may also be acquired by directly using a mapping relationship between a square area and an operation instruction. Table 3 below indicates mapping relationships between nine square areas into which a captured image is evenly divided and corresponding operation instructions.

TABLE 3
Mapping relationship between a square area and an operation instruction

| | | |
|---|---|---|
| Operation instruction: | Operation instruction: | Operation instruction: |
| turn up volume | reserved | switch to a next channel |
| Operation instruction: | Operation instruction: | Operation instruction: |
| turn down volume | reserved | reserved |
| Operation instruction: | Operation instruction: | Operation instruction: |
| mute | reserved | switch to a next channel |

In the manner 2), the acquiring the corresponding operation instruction according to a combined gesture formed by the multiple motion tracks of the multiple auxiliary light sources in the captured area may include, but is not limited to: querying a mapping relationship, stored in a code library, between the number of square areas, a direction, and a code according to the number of square areas passed by the motion tracks (moving simultaneously) in the captured area in which the auxiliary light sources are located and a direction thereof, for a code corresponding to the number of the square areas passed by the auxiliary light sources and the direction thereof, so as to acquire, according to the obtained code, an operation instruction corresponding to the code from the mapping relationship, stored in a code and instruction mapping library, between a code and an operation instruction. The table below shows the mapping relationship between the number of square areas passed by the auxiliary light sources, a direction, and a code:

TABLE 4
Mapping relationship between the number of square areas by
the auxiliary light sources, a direction, and a code

| Code | Motion track |
|---|---|
| a | The auxiliary light sources pass three square areas downward |
| b | The auxiliary light sources pass three square areas to the right |
| c | The auxiliary light sources pass three square areas obliquely |
| | upward |

For example, when the human-computer interaction terminal determines that the multiple auxiliary light sources simultaneously pass three square areas downward, from the mapping relationship, shown in Table 4 and stored in the code library, between the number of square areas passed by the auxiliary light sources, a direction, and a code, the human-computer interaction terminal may obtain by query, by using control software, the corresponding code a when the auxiliary light sources pass three square areas downward; when the multiple auxiliary light sources simultaneously pass three square areas to the right, the motion tracks correspond to the code b; when the multiple auxiliary light sources simultaneously pass three square areas obliquely upward, the motion tracks correspond to the code c.

TABLE 5
Mapping relationship, stored in the code and instruction mapping
library, between a code and an operation instruction

| Code | Instruction | Description |
|---|---|---|
| a | Scroll content | When the auxiliary light sources pass three square |
| | down | areas downward, scroll the content down |
| b | Magnify a | When the auxiliary light sources pass three square |
| | picture | areas obliquely upward, magnify the picture |
| c | Turn to a next | When the auxiliary light sources pass three square |
| | page | areas to the right, turn to the next page |

As shown in Table 5, a corresponding operation instruction can be acquired in the mapping relationship between a code and an operation instruction in the table above according to a code obtained by query according to the motion tracks. For example, when the human-computer interaction terminal obtains, from Table 4 according to the motion tracks of the auxiliary light sources in the captured area, that the motion tracks of the auxiliary light sources correspond to the code a, the operation instruction “scroll content down” can be further acquired from Table 5, and at this time, the human-computer interaction terminal may execute the operation instruction, and scrolling the content down.

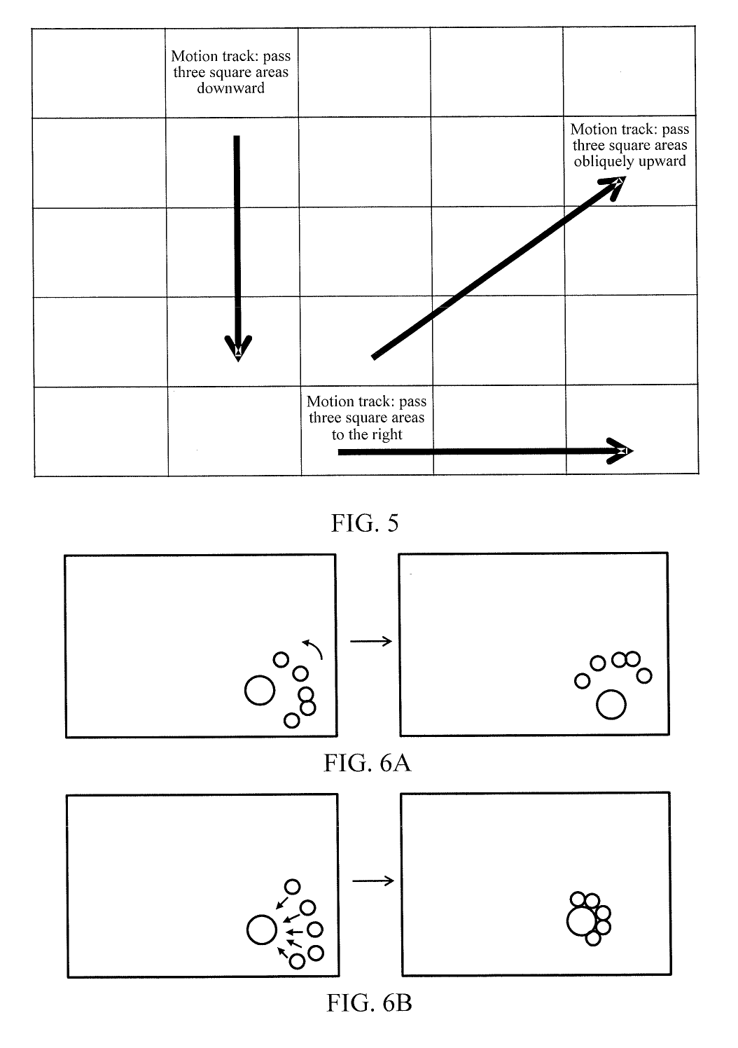

In another embodiment, the operation instruction corresponding to the motion tracks of the auxiliary light sources in the captured area may also be acquired by directly using a mapping relationship between the number of square areas, a direction, and an operation instruction. As shown in FIG. 5, the operation instructions respectively corresponding to motion tracks in the mapping relationship are that: an operation instruction corresponding to that the multiple auxiliary light sources simultaneously move downward by three square areas is to scroll interface content down; an operation instruction corresponding to that the multiple auxiliary light sources simultaneously move to the right by three square areas is a page turning operation; and an operation instruction corresponding to that the multiple auxiliary light sources simultaneously move obliquely upward by three square areas is to increase an interface display ratio.

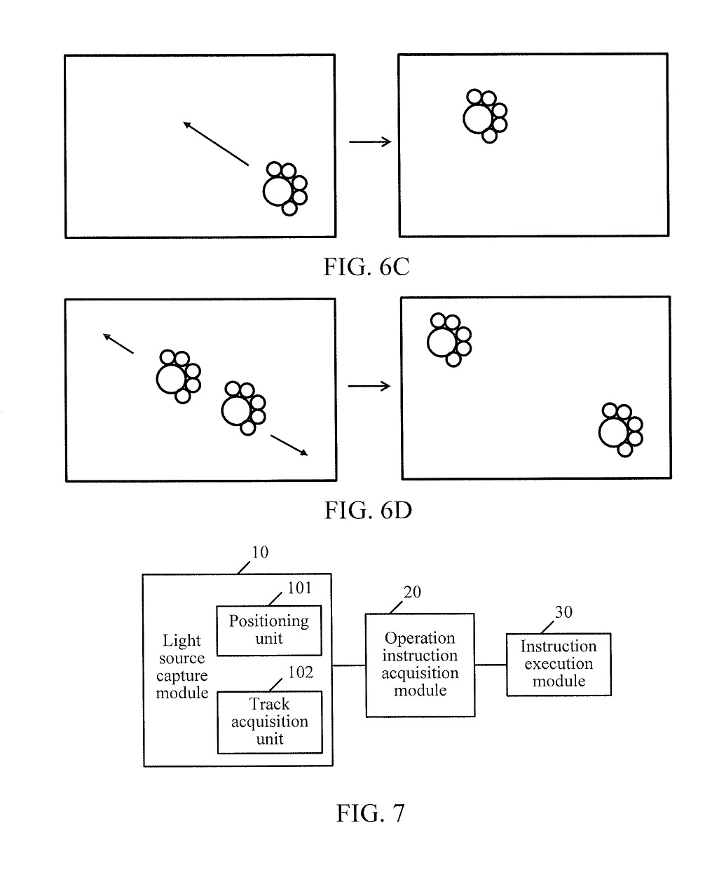

In the manner 3), the acquiring the corresponding operation instruction by acquiring a combined gesture formed by the positions of the multiple auxiliary light sources and a combined gesture formed by the motion tracks of the multiple auxiliary light sources may be similar to the principle of acquiring the corresponding operation instruction of the manner 1) or manner 2) described above, where a corresponding code may be queried for according to the acquired combined gesture formed by the positions of the multiple auxiliary light sources and the acquired combined gesture formed by the motion tracks of the multiple auxiliary light sources, and the corresponding operation instruction is further acquired according to the obtained code, or the operation instruction corresponding to the combined gestures may also be directly acquired according to the identified combined gestures. For example, the multiple auxiliary light sources are respectively disposed on the auxiliary light source gloves shown in FIG. 2 at the multiple positions corresponding to the fingers and/or palm of the human hand. The corresponding operation instruction can be acquired according to the combined gesture formed by the positions and/or motion tracks of the auxiliary light sources corresponding to the fingers and/or palm. By using combined gestures shown in FIG. 6A to FIG. 6D as examples, FIG. 6A is a combined gesture of rotation when fingers of an auxiliary light source glove are open, and an operation instruction corresponding to the combined gesture may be to control a rotary button of a terminal to rotate along a rotation direction of a palm (a clockwise or counterclockwise direction); FIG. 6B is a combined gesture that an auxiliary light source glove folds fingers from a finger open state, and an operation instruction corresponding to the combined gesture may be to simulate a click operation of a mouse: press a button of a terminal; FIG. 6C is a combined gesture that an auxiliary light source glove moves in a finger folded state, and an operation instruction corresponding to the combined gesture may be to simulate an operation of pressing and holding a mouse to drag, and for a touch screen terminal, it may be to simulate an operation of sliding a finger on a screen, which may specifically be combined with that in FIG. 6B to be an operation instruction of grabbing an icon or button to drag; and FIG. 6D is a combined gesture of an action of unfolding both hands when fingers of two auxiliary light source gloves are folded, and an operation instruction corresponding to the combined gesture may be to increase a ratio of a current terminal display interface; and the corresponding combined gesture may also be an action of folding the both hands when the fingers of the two auxiliary light source gloves are folded, and an operation instruction corresponding to the combined gesture may be to reduce a ratio of the current terminal display interface, and another corresponding manner that can be conceived by a person skilled in the art also falls within the scope of the present disclosure.

Step S103: Execute the acquired operation instruction. In this embodiment, the operation instruction may include, but is not limited to, a computer operation instruction (for example, a mouse operation instruction such as opening, closing, magnifying, and reducing) or a television remote control instruction (for example, a remote control operation instruction such as turning on, turning off, turning up volume, turning down the volume, switching to a next channel, switching to a previous channel, and muting).

The human-computer interaction method according to an embodiment of the present disclosure is described above in detail.

According to another embodiment of the present disclosure, a human-computer interaction terminal is further provided.

Referring to FIG. 7, FIG. 7 is a schematic structural diagram of a human-computer interaction terminal according to another embodiment of the present disclosure. The human-computer interaction terminal may be a computer, a smartphone, a television, or various home intelligent devices, commercial intelligent devices, office intelligent devices, MIDs, and the like that is loaded with control software and has a computing capability, which is not specifically limited in this embodiment of the present disclosure. As shown in FIG. 7, the human-computer interaction terminal in this embodiment of the present disclosure has one or more processors, memory, and one or more program modules stored in the memory and to be executed by the one or more processors, the one or more program modules further including: a light source capture module 10, an operation instruction acquisition unit 20, and an instruction execution module 30.

In some embodiments, the memory includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory includes one or more storage devices remotely located from the processor. The memory, or alternately the non-volatile memory device(s) within the memory, includes a non-transitory computer readable storage medium. In some embodiments, the memory, or the non-transitory computer readable storage medium of memory, stores the programs, program modules, and data structures, or a subset or superset thereof as described above.

The light source capture module 10 acquires positions and/or motion tracks of multiple auxiliary light sources in a captured area by using a camera. According to this embodiment of the present disclosure, the camera may be built in the human-computer interaction terminal, where the human-computer interaction terminal includes, but is not limited to, a terminal device such as: a notebook computer, a tablet, a smartphone, and a PDA, for example, a camera built in a terminal such as a notebook computer, a smartphone, a tablet, or a PDA; and the camera may also be externally connected to the human-computer interaction terminal, for example, the camera may be connected to the human-computer interaction terminal by using a USB, or may be connected to the human-computer interaction terminal by using a WAN, or the camera may also be connected to the human-computer interaction terminal in a wireless manner, such as Bluetooth, Wi-Fi, or infrared. In an embodiment of the present disclosure, the camera may be built in the human-computer interaction terminal, or be externally connected to the human-computer interaction terminal, or the two manners are combined. A connection manner between the camera and the human-computer interaction terminal may be: a wired connection, a wireless connection or a combination of the two connection manners.

The multiple auxiliary light sources mentioned in this embodiment of the present disclosure may be disposed on a component suitable for being worn on a human hand, for example, disposed on auxiliary light source gloves shown in FIG. 2 at multiple positions corresponding to fingers and/or a palm of a human hand. The position or motion track of each auxiliary light source is distinguished according to any one of or a combination of more than one of the size, shape, and color of the multiple auxiliary light sources, for example, a light source at the palm and light sources at the fingers are distinguished by using the luminous area, where a light source with a large luminous area may be disposed at a palm of a glove, and two to five light sources with a small area may be disposed at fingers; and light sources on auxiliary light source gloves of a left hand and a right hand may be distinguished by using light sources whose pattern designs are easy to be identified, or light sources on different auxiliary light source gloves may also be distinguished by using light sources of different colors. The auxiliary light sources may be visible-light light sources, and may also be infrared light sources. Correspondingly, when the auxiliary light sources are visible-light auxiliary light sources, the camera is a visible-light camera, and when the auxiliary light sources are infrared light sources, the camera needs to be an infrared camera that can acquire an infrared image.

In an embodiment of the present disclosure, the positions of the auxiliary light sources in the captured area that are acquired by the light source capture module 10 by using the camera may be the positions of the auxiliary light sources in an image captured by the camera, for example, the image captured by the camera is divided into multiple subareas, and a subarea in which the auxiliary light sources are located is distinguished, and is regarded as the relative position of the auxiliary light sources in the captured area. In this embodiment of the present disclosure, the light source capture module 10 may further include: a positioning unit 101, acquiring a subarea in which the positions of the multiple auxiliary light sources are located; and/or a track acquisition unit 102, acquiring a subarea passed by the motion tracks of the multiple auxiliary light sources and a moving direction thereof. According to an embodiment of the present disclosure, if the auxiliary light sources move in the captured area, the multiple auxiliary light sources may be continuously identified by using an image sequence acquired by the camera within a preset continuous time, so that motion tracks of the multiple auxiliary light sources in the captured area can be obtained, and the number of subareas passed by the motion tracks of the auxiliary light sources and a moving direction thereof can further be obtained, where the position or motion track of each auxiliary light source in the captured area may be distinguished according to any one of or a combination of more than one of the size, shape, and color of the multiple auxiliary light sources.

The operation instruction acquisition module 20 acquires a corresponding operation instruction according to a combined gesture formed by the acquired positions and/or motion tracks of the multiple auxiliary light sources in the captured area. In specific implementation, in an embodiment of the present disclosure, the following three different implementation manners are available for acquiring the corresponding operation instruction according to the positions and/or motion tracks of the multiple auxiliary light sources in the captured area: 1) acquiring the corresponding operation instruction according to a combined gesture formed by the multiple positions of the multiple auxiliary light sources in the captured area; 2) acquiring the corresponding operation instruction according to a combined gesture formed by the multiple motion tracks of the multiple auxiliary light sources in the captured area; and 3) acquiring the corresponding operation instruction by acquiring a combined gesture formed by the positions of the multiple auxiliary light sources and a combined gesture formed by the motion tracks of the multiple auxiliary light sources.

The foregoing three methods for acquiring the corresponding operation instruction have already been described in detail in the foregoing method embodiment of the present disclosure, and details are not described again herein.

The instruction execution module 30 executes the operation instruction acquired by the operation instruction acquisition module 20.

The human-computer interaction terminal according to an embodiment of the present disclosure is described above in detail.

According to another embodiment of the present disclosure, a human-computer interaction system is further provided. The human-computer interaction system includes multiple auxiliary light sources and the human-computer interaction terminal shown in FIG. 7.

The human-computer interaction terminal acquires positions and/or motion tracks of the multiple auxiliary light sources in a captured area by using a camera, acquires a corresponding operation instruction according to a combined gesture formed by the acquired positions and/or motion tracks of the multiple auxiliary light sources in the captured area, and executes the acquired operation instruction.

The multiple auxiliary light sources may be shown as FIG. 2, disposed on a component suitable for being worn on a human hand at multiple positions corresponding to fingers and/or a palm of a human hand. The human-computer interaction terminal acquires the corresponding operation instruction according to the combined gesture formed by the positions and/or motion tracks of the auxiliary light sources corresponding to the fingers and/or palm.

According to an embodiment of the present disclosure, according to the human-computer interaction method shown in FIG. 1, the human-computer interaction method may be executed by units in the human-computer interaction terminal shown in FIG. 7. For example, step S101 shown in FIG. 1 may be executed by the light source capture module 10 shown in FIG. 7. Step S102 shown in FIG. 1 may be executed by the operation instruction acquisition unit 20 shown in FIG. 7. Step S103 shown in FIG. 1 may be executed by the instruction execution module 30 shown in FIG. 7 in combination with the operation instruction acquisition unit 20.

According to another embodiment of the present disclosure, the units in the human-computer interaction terminal shown in FIG. 7 may be merged into one or several other modules separately or entirely for composition, or some module (some modules) therein may further be split into multiple functionally smaller modules for composition, which can implement same operations, without affecting the implementation of technical effects of embodiments of the present disclosure. The foregoing units are divided based on logical functions, and in an actual application, functions of one unit may also be implemented by using multiple units, or functions of multiple units are implemented by using one unit. In another embodiment of the present disclosure, the human-computer interaction terminal may also include other modules. However, in an actual application, these functions may also be implemented with the help of another unit, and may be implemented with the help of multiple units.

According to still another embodiment of the present disclosure, a computer program (including program code) that can execute the human-computer interaction method shown in FIG. 1 may run on, for example, a universal computing device of a computer, which includes a processing element and a storage element such as a central processing unit (CPU), a random access memory (RAM), and a read-only memory (ROM), to constitute the human-computer interaction terminal shown in FIG. 7, and to implement the human-computer interaction method according to the embodiments of the present disclosure. The computer program may be recorded on, for example, a computer readable recording medium, and is loaded into and run in the foregoing computing device by using the computer readable recording medium.

In summary, according to the human-computer interaction method, terminal and system according to the embodiments of the present disclosure, positions and/or motion tracks of auxiliary light sources in a captured area can be acquired by using a camera, so that an operation instruction corresponding to the positions and/or motion tracks of the auxiliary light sources can be acquired, and the operation instruction can be executed. In the human-computer interaction method of the embodiments of the present disclosure, human-computer interaction is based on the auxiliary light sources, which not only has very good interference immunity and higher manipulation accuracy, but also has a good commercial value.

A person of ordinary skill in the art may understand that all or some of the steps of the methods in the embodiments may be implemented by a program instructing related hardware. The program may be stored in a computer-readable storage medium. The storage medium may include: a flash drive, a ROM, a RAM, a magnetic disk, or an optical disc.

The embodiments of the present disclosure are described above, but they are not used to limit the scope of the present disclosure. The scope of the present disclosure is defined by appended claims. Any modification, equivalent replacement, and improvement made without departing from the spirit and principle of the present disclosure shall fall within the protection scope of the present disclosure.

What is claimed is:

1. A human-computer interaction method, comprising:
at a terminal device having one or more processors and memory for storing program modules to be executed by the one or more processors:
acquiring positions and/or motion tracks of multiple auxiliary light sources in a captured area by using a camera;
acquiring a corresponding operation instruction according to a combined gesture formed by the acquired positions and/or motion tracks of the multiple auxiliary light sources in the captured area; and
executing the acquired operation instruction.

2. The human-computer interaction method according to claim 1, wherein the step of acquiring positions and/or motion tracks of multiple auxiliary light sources in a captured area by using a camera further includes:
distinguishing the position or motion track of each auxiliary light source according to any one of or a combination of at least two of the size, shape, and color of the multiple auxiliary light sources.

3. The human-computer interaction method according to claim 1, wherein the multiple auxiliary light sources are disposed on a component suitable for being worn on a human hand.

4. The human-computer interaction method according to claim 3, wherein the multiple auxiliary light sources are disposed on the component at multiple positions corresponding to fingers and/or a palm of a human hand.

5. The human-computer interaction method according to claim 4, wherein the step of acquiring a corresponding operation instruction according to a combined gesture formed by the acquired positions and/or motion tracks of the multiple auxiliary light sources in the captured area further includes:
acquiring the corresponding operation instruction according to the combined gesture formed by the positions and/or motion tracks of the auxiliary light sources corresponding to the fingers and/or palm.

6. The human-computer interaction method according to claim 1, wherein the captured area is divided into multiple subareas, and the step of acquiring positions and/or motion tracks of multiple auxiliary light sources in a captured area by using a camera further includes:
acquiring a subarea in which the positions of the multiple auxiliary light sources are located.

7. The human-computer interaction method according to claim 1, wherein the captured area is divided into multiple subareas, and the step of acquiring positions and/or motion tracks of multiple auxiliary light sources in a captured area by using a camera further includes:
acquiring a subarea passed by the motion tracks of the multiple auxiliary light sources and a moving direction thereof.

8. The human-computer interaction method according to claim 1, wherein the camera is an infrared camera, and the auxiliary light sources are infrared auxiliary light sources.

9. The human-computer interaction method according to claim 1, wherein the camera is a visible-light camera, and the auxiliary light sources are visible-light auxiliary light sources.

10. A human-computer interaction terminal having one or more processors, memory, and one or more program modules stored in the memory and to be executed by the one or more processors, the one or more program modules further comprising:
a light source capture module, configured to acquire positions and/or motion tracks of multiple auxiliary light sources in a captured area by using a camera;
an operation instruction acquisition module, configured to acquire a corresponding operation instruction according to a combined gesture formed by the acquired positions and/or motion tracks of the multiple auxiliary light sources in the captured area; and
an instruction execution module, configured to execute the acquired operation instruction.

11. The human-computer interaction terminal according to claim 10, wherein the light source capture module distinguishes the position or motion track of each auxiliary light source according to any one of or a combination of more of the size, shape, and color of the multiple auxiliary light sources.

12. The human-computer interaction terminal according to claim 11, wherein the multiple auxiliary light sources are disposed at multiple positions corresponding to fingers and/or a palm of a human hand, on a component suitable for being worn on a human hand, and
the operation instruction acquisition module is specifically configured to:
acquire the corresponding operation instruction according to the combined gesture formed by the positions and/or motion tracks of the auxiliary light sources corresponding to the fingers and/or palm.

13. The human-computer interaction terminal according to claim 10, wherein the captured area is divided into multiple subareas, and the light source capture module further includes:
a positioning unit, configured to acquire a subarea in which the positions of the multiple auxiliary light sources are located.

14. The human-computer interaction terminal according to claim 10, wherein the captured area is divided into multiple subareas, and the light source capture module further includes:
a track acquisition unit, configured to acquire a subarea passed by the motion tracks of the multiple auxiliary light sources and a moving direction thereof.

15. The human-computer interaction terminal according to claim 10, wherein the camera is an infrared camera, and the auxiliary light sources are infrared auxiliary light sources.

16. The human-computer interaction terminal according to claim 10, wherein the camera is a visible-light camera, and the auxiliary light sources are visible-light auxiliary light sources.

17. A non-transitory computer readable medium storing one or more program modules, wherein the one or more program modules, when executed by a human-computer interaction terminal having one or more processors, cause the human-computer interaction terminal to perform the following steps:
acquiring positions and/or motion tracks of multiple auxiliary light sources in a captured area by using a camera;
acquiring a corresponding operation instruction according to a combined gesture formed by the acquired positions and/or motion tracks of the multiple auxiliary light sources in the captured area; and
executing the acquired operation instruction.

18. The non-transitory computer readable medium according to claim 17, wherein the light source capture module distinguishes the position or motion track of each auxiliary light source according to any one of or a combination of more of the size, shape, and color of the multiple auxiliary light sources.

19. The non-transitory computer readable medium according to claim 17, wherein the captured area is divided into multiple subareas, and the step of acquiring positions and/or motion tracks of multiple auxiliary light sources in a captured area by using a camera further includes:
acquiring a subarea in which the positions of the multiple auxiliary light sources are located.

20. The non-transitory computer readable medium according to claim 17, wherein the captured area is divided into multiple subareas, and the step of acquiring positions and/or motion tracks of multiple auxiliary light sources in a captured area by using a camera further includes:
acquiring a subarea passed by the motion tracks of the multiple auxiliary light sources and a moving direction thereof.
